(19) United States
(12) Patent Application Publication
(10) Pub. No.: US 2025/0355322 A1
(43) Pub. Date: Nov. 20, 2025

(54) PROJECTOR LENS APERTURES FOR PROJECTION SYSTEMS

(71) Applicant: DOLBY LABORATORIES LICENSING CORPORATION

(72) Inventors: Duane Scott Dewald, Dallas, TX (US); John David Jackson, Allen, TX (US)

(73) Assignee: DOLBY LABORATORIES LICENSING CORPORATION, (US)

(21) Appl. No.: 18/864,293

(22) PCT Filed: May 8, 2023
(86) PCT No.: PCT/US2023/021383

§ 371 Date: Nov. 8, 2024

(51) Int. Cl. G03B 9/02

(52) U.S. Cl. CPC G03B 9/02

(57) ABSTRACT

Projection lens apertures for laser-based image projection systems (100). One embodiment provides a projection lens assembly (112) for a projector system (100). The projection lens assembly (112) includes an aperture (1200, 1300, 1800, 1900) integrated within the projection lens assembly and configured to block a portion of incident light. The aperture includes an aperture hole (1205, 1305, 1805, 1905) composed of at least three edges (1215, 1315,1815, 1915) and a plurality of vertices (1210, 1310, 1810, 1910). The at least three edges are curved relative to a center of the aperture hole.

### CROSS REFERENCE TO RELATED APPLICATIONS

This application claims priority to U.S. provisional application 63/340,693 filed 11 May 2022, which is incorporated herein by reference in its entirety.

### BACKGROUND

### 1. Field of the Disclosure

This application relates generally to projection systems and, particularly, to projection lens apertures for laser-based image projection systems.

### 2. Description of Related Art

Digital projection systems typically utilize a light source and an optical system to project an image onto a surface or screen. The optical system includes components such as mirrors, lenses, waveguides, optical fibers, beam splitters, diffusers, spatial light modulators (SLMs), phase light modulators (PLMs), and the like. Some optical systems include a projector lens aperture. The projector lens aperture is typically a circular shape.

### BRIEF SUMMARY OF THE DISCLOSURE

While a projection lens apertures are typically circular, square or rectangular aperture may instead be used that match the shape of pixels on modulation devices. However, square apertures experience a higher rate of artifacts that degrade image quality. Circular apertures provide some improvements in artifacts, resulting in a higher resolution and finer contrast in the projected image. Accordingly, there is a need to further decrease artifacts in the image while maintaining modulation.

Embodiments described herein provide for apertures with non-straight sections. Such apertures capture the diffraction orders required for high contrast projection while reducing artifacts that reduce resolution by blurring pixels vertically and horizontally. Additionally, apertures described herein may reduce the visibility of lines between the pixels on the projected display.

Various aspects of the present disclosure relate to devices, systems, and methods for projection display.

In one exemplary aspect of the present disclosure, there is provided a projection lens assembly for a projector system comprises an aperture integrated within the projection lens assembly and configured to block a portion of incident light. The aperture includes an aperture hole composed of at least three edges and a plurality of vertices. The at least three edges are curved relative to a center of the aperture hole.

In another exemplary aspect of the present disclosure, there is provided a method of providing a projection lens assembly. The method comprises providing a Fourier lens assembly configured to form a Fourier transform of an object at an exit pupil of the Fourier lens assembly, and disposing an aperture approximately at a plane of the Fourier transform, the aperture configured to block a portion of incident light. The aperture includes an aperture hole composed of at least three edges and a plurality of vertices. The at least three edges are curved relative to a center of the aperture hole.

In another exemplary aspect of the present disclosure, there is provided a projector. The projector comprises a light source, a modulator, and a projection lens assembly. The light source is configured to emit a light in response to an image signal, the image signal including image data. The modulator is configured to receive the light from the light source and to apply a spatially-varying modulation on the light, thereby to steer the light and to generate a first steered light. The projection lens assembly is configured to receive the first steered light from the modulator. The projection lens assembly includes an aperture configured to block a portion of incident light. The aperture includes an aperture hole composed of a plurality of concave edges and a plurality of convex edges.

In this manner, various aspects of the present disclosure provide for the display of images having a high dynamic range and high resolution, and effect improvements in at least the technical fields of image projection, holography, signal processing, and the like.

### DESCRIPTION OF THE DRAWINGS

These and other more detailed and specific features of various embodiments are more fully disclosed in the following description, reference being had to the accompanying drawings, in which:

FIG. 1 illustrates a block diagram of an exemplary image projector display system according to various aspects of the present disclosure;

FIG. 2 illustrates an optical configuration of an exemplary projector system according to various aspects of the present disclosure;

FIG. 3A illustrates a plan view of an exemplary spatial light modulator for use with various aspects of the present disclosure;

FIG. 3B illustrates a cross-sectional view taken along the line II-B of FIG. 2A;

FIG. 4 illustrates a plan view of an exemplary phase light modulator for use with various aspects of the present disclosure;

FIG. 5 illustrates a cross-sectional view of another exemplary phase light modulator for use with various aspects of the present disclosure; and

FIG. 6 illustrates a cross-sectional view of an exemplary optical fiber according to various aspects of the present disclosure.

FIG. 7 illustrates an exemplary projection lens according to various aspects of the present disclosure.

FIG. 8 illustrates an exemplary diffraction of a point source with a square projection aperture according to various aspects of the present disclosure.

FIG. 9 illustrates an exemplary diffraction from a point source with a circular projection aperture according to various aspects of the present disclosure.

FIG. 10 illustrates an exemplary simulated pixel focus with diffraction using a rectangular aperture according to various aspects of the present disclosure.

FIG. 11 illustrates an exemplary simulated pixel focus with diffraction using a circular aperture according to various aspects of the present disclosure.

FIG. 12 illustrates an exemplary pincushion-shaped aperture according to various aspects of the present disclosure.

FIG. 13 illustrates an exemplary pillow-shaped aperture according to various aspects of the present disclosure.

FIG. 14 illustrates an exemplary diffraction image of a point source with the pincushion-shaped aperture according to various aspects of the present disclosure.

FIG. 15 illustrates an exemplary diffraction image of a point source with the pillow-shaped aperture according to various aspects of the present disclosure.

FIG. 16 illustrates an exemplary pixel focus with diffraction using the pincushion-shaped aperture according to various aspects of the present disclosure.

FIG. 17 illustrates an exemplary pixel focus with diffraction using the pillow-shaped aperture according to various aspects of the present disclosure.

FIG. 18 illustrates an exemplary cross-shaped aperture according to various aspects of the

present disclosure.

FIG. 19 illustrates an exemplary asymmetrical aperture according to various aspects of the present disclosure.

### DETAILED DESCRIPTION

This disclosure and aspects thereof can be embodied in various forms, including hardware, devices, or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing summary is intended solely to give a general idea of various aspects of the present disclosure, and does not limit the scope of the disclosure in any way.

In the following description, numerous details are set forth, such as optical device configurations, timings, operations, and the like, in order to provide an understanding of one or more aspects of the present disclosure. It will be readily apparent to one skilled in the art that these specific details are merely exemplary and not intended to limit the scope of this application.

Moreover, while the present disclosure focuses mainly on examples in which the various circuits are used in digital projection systems, it will be understood that this is merely one example of an implementation. It will further be understood that the disclosed systems and methods can be used in any device in which there is a need to project light; for example, cinema, consumer, and other commercial projection systems, heads-up displays, virtual reality displays, and the like.

### Projector Systems

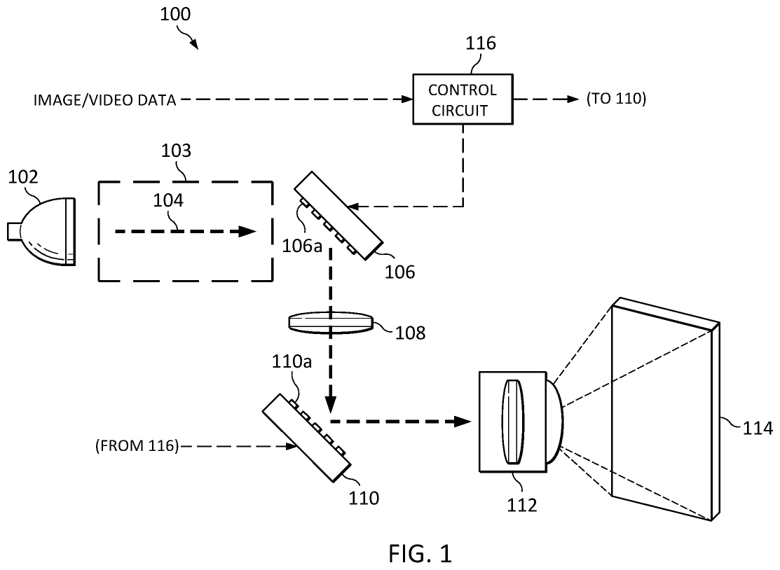

FIG. 1 illustrates one possible embodiment of a suitable image projector display system. In the illustrated embodiment, the projector display system is constructed as a dual/multi-modulator projection system 100. The projection system 100 employs a light source 102 that supplies the projector system with a desired illumination such that a final projected image will be sufficiently bright for the intended viewers of the projected image. Light source 102 may comprise any suitable light source, such as, but not limited to, Xenon lamps, laser(s), coherent light sources, and partially-coherent light sources. Additionally, optical systems described herein may implement optical fibers to transfer light from the light source 102 to optics within the optical system. While a light source and a rectangular optic fiber may be referred to separately, it is to be understood that the rectangular optic fiber is a component of the light source. Thus, reference to only the light source does not exclude the rectangular optic fiber.

Light 104 from the light source 102 may illuminate a first modulator 106 that may, in turn, illuminate a second modulator 110 via a set of optional optical components 108. Light from the second modulator 110 may be projected by a projection lens 112 (or other suitable optical components) to form a final projected image upon a screen 114. The first modulator 106 and the second modulator 110 may be controlled by a controller 116. The controller 116 may receive input image and/or video data and may perform certain image processing algorithms, gamut mapping algorithms or other such suitable processing upon the input image/video data and output control/data signals to the first modulator 106 and the second modulator 110 in order to achieve a desired final projected image on the screen 114. In addition, in some projector systems, it may be possible, depending on the light source, to modulate light source 102 (control line not shown) in order to achieve additional control of the image quality of the final projected image.

Light recycling module 103 is depicted in FIG. 1 as a dotted box that may be placed in the light path from the light source 102 to the first modulator 106. It may be appreciated that light recycling may be inserted into the projector system at various points in the projector system. For example, light recycling may be placed between the first and second modulators. In addition, light recycling may be placed at more than one point in the optical path of the display system.

While the embodiment of FIG. 1 is presented in the context of a dual, multi-modulation projection system, it should be appreciated that the techniques and methods of the present application will find application in single modulation, or other dual, multi-modulation display systems. For example, a dual modulation display system comprising a backlight, a first modulator (e.g., LCD or the like), and a second modulator (e.g., LCD or the like) may employ suitable optical components and image processing methods and techniques to affect the performance and efficiencies discussed herein in the context of the projection systems. If should also be appreciated that, even though FIG. 1 depicts a two-stage or dual modulator display system, the methods and techniques of the present application may also find application in a display system with only one modulator or a display system with three or more modulator (multi-modulator) display systems. The scope of the present application encompasses these various alternative embodiments.

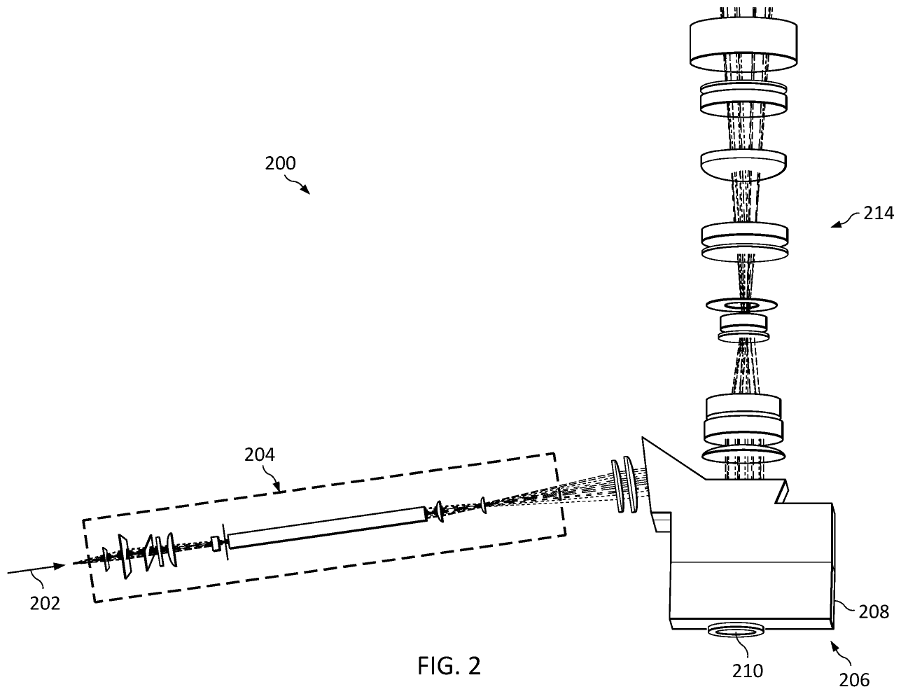

FIG. 2 illustrates another example projection system 200. The projection system 200 includes an illumination assembly 204 (e.g., illumination optics) that receives light from a fiber input 202 and feeds the light into a modulation assembly 206. The modulation assembly 206 includes a prism 208 and a modulator 210 (e.g., a reflector device). The modulator 210 may be configured as a digital light processing (DLP) device, as described below in more detail.

In some instances, the light from the fiber input 202 is a white light input, and the prism 208 is a white light prism. In such an instance, the prism 208 includes several prism pieces. For example, a spectral filter, such as a yellow notch filter, may be provided in the prism 208. Additional pieces may function as a TIR prism. In some embodiments, the modulation assembly 206 includes three modulators 210 (e.g., 3-chip) for modulating the received white light. The prism 208 splits the white light into several color beams (e.g., three color channels), one color beam for each modulator 210. A controller (such as the controller 116) may be coupled to each modulator 210 to control modulation of each color beam. The modulators 210 then modulate their respective color beam before combining the modulated color beams in the prism 208. In other embodiments, the modulator 210 modulates the white light directly. In both embodiments, the modulation assembly 206 then relays the output beam into projection optics 214 of the projection system 200. In some embodiments, the projection optics 214 are included in a projection lens. In other embodiments, a portion or section of the projection optics 214 are included in the projection lens.

In other instances, the projection system 200 includes several fiber inputs 202 from several color channels, such as a red color channel, a blue color channel, and a green color channel. In such an instance, the illustrated illumination assembly 204 receiving the fiber input 202 corresponds to only a single color channel. Several illumination assemblies 204 may be included to direct the light from the fiber inputs to the prism 208. In such an instance, the prism 208 is a color light prism that receives each fiber input 202 and redirects each color channel to a respective modulator 210. Following modulation, the modulated color channels are combined and directed towards the projection optics 214.

### Exemplary Modulation Devices

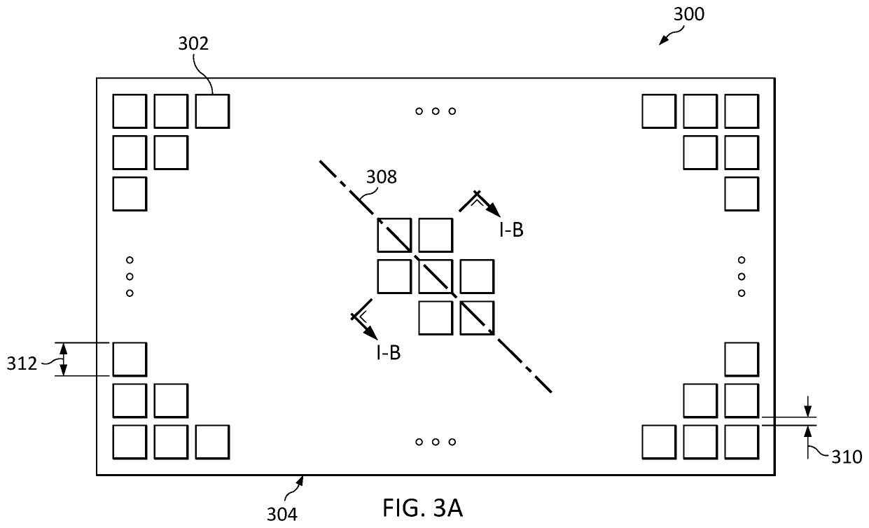

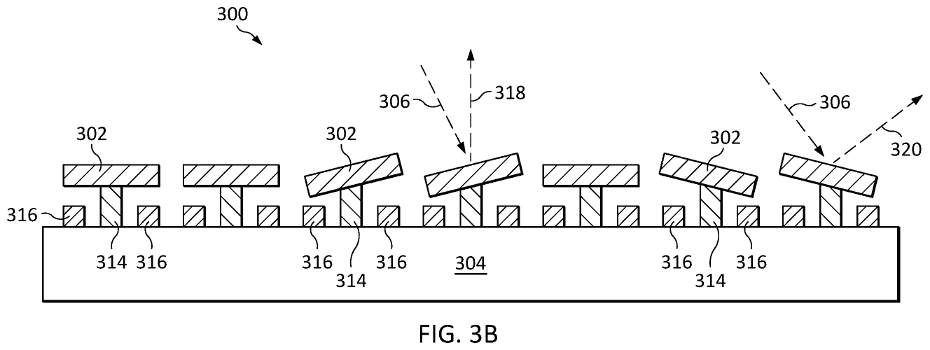

The modulator 210 (and, in some implementations, the first modulator 106 and the second modulator 110 in FIG. 1) may be configured as a DLP device. In some implementations, the modulator 210 is a digital micromirror device (DMD) composed of a plurality of mirrors used to adjust the angle of incidence of light. To illustrate the effects of the angle of incidence and the DMD mirrors, FIGS. 3A-3B show an exemplary DMD 300 in accordance with various aspects of the present disclosure. In particular, FIG. 3A illustrates a plan view of the DMD 300, and FIG. 3B illustrates partial cross-sectional view of the DMD 300 taken along line I-B illustrated in FIG. 3A. The DMD 300 includes a plurality of square micromirrors 302 arranged in a two-dimensional rectangular array on a substrate 304. Each micromirror 302 may correspond to one pixel of the eventual projection image, and may be configured to tilt about a rotation axis 308, shown for one particular subset of the micromirrors 302, by electrostatic or other type of actuation. The individual micromirrors 302 have a width 312 and are arranged with gaps of width 310 therebetween. The micromirrors 302 may be formed of or coated with any highly reflective material, such as aluminum or silver, to thereby specularly reflect light. The gaps between the micromirrors 302 may be absorptive, such that input light which enters a gap is absorbed by the substrate 304.

While FIG. 3A expressly shows only some representative micromirrors 302, in practice the DMD 300 may include many more individual micromirrors in a number equal to a resolution of the projection system 200. In some examples, the resolution may be 2K (2048×1080), 4K (4096×2160), 1080p (1920×1080), consumer 4K (3840×2160), and the like. Moreover, in some examples the micromirrors 302 may be rectangular and arranged in the rectangular array; hexagonal and arranged in a hexagonal array, and the like. Moreover, while FIG. 3A illustrates the rotation axis 308 extending in an oblique direction, in some implementations the rotation axis 308 may extend vertically or horizontally.

As can be seen in FIG. 3B, each micromirror 302 may be connected to the substrate 304 by a yoke 314, which is rotatably connected to the micromirror 302. The substrate 304 includes a plurality of electrodes 316. While only two electrodes 316 per micromirror 302 are visible in the cross-sectional view of FIG. 3B, each micromirror 302 may in practice include additional electrodes. While not particularly illustrated in FIG. 3B, the DMD 300 may further include spacer layers, support layers, hinge components to control the height or orientation of the micromirror 302, and the like. The substrate 304 may include electronic circuitry associated with the DMD 300, such as complementary metal-oxide semiconductor (CMOS) transistors, memory elements, and the like.

Depending on the particular operation and control of the electrodes 316, the individual micromirrors 302 may be switched between an “on” position, an “off” position, and an unactuated or neutral position. If a micromirror 302 is in the on position, it is actuated to an angle of (for example) −12° (that is, rotated counterclockwise by 12° relative to the neutral position) to specularly reflect input light 306 into on-state light 318. If a micromirror 302 is in the off position, it is actuated to an angle of (for example) +12° (that is, rotated clockwise by 12° relative to the neutral position) to specularly reflect the input light 306 into off-state light 320. The off-state light 320 may be directed toward a light dump that absorbs the off-state light 320. In some instances, a micromirror 302 may be unactuated and lie parallel to the substrate 304. The particular angles illustrated in FIGS. 3A-3B and described here are merely exemplary and not limiting. In some implementations, the on-and off-position angles may be between ±11 and ±13 degrees (inclusive), respectively. In other implementations, the on-and off-position angles may be between ±10 and ±18 degrees (inclusive), respectively.

In some implementations, the modulator 210 is a phase light modulator (PLM) configured to impart a spatially-varying phase modulation to the light. The PLM may be a reflective type, in which the PLM reflects incident light with a spatially-varying phase; alternatively, the PLM may be of a transmissive type, in which the PLM imparts a spatially-varying phase to light as it passes through the PLM. In some aspects of the present disclosure, the PLM has a liquid crystal on silicon (LCOS) architecture. In other aspects of the present disclosure, the PLM has a micro-electromechanical system (MEMS) architecture.

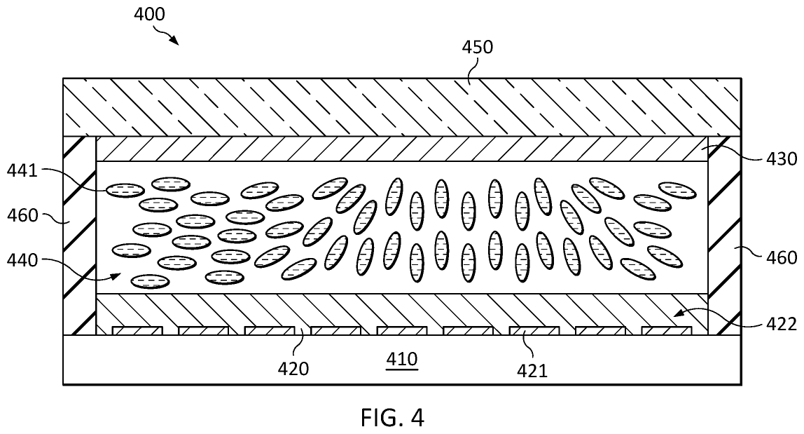

FIG. 4 illustrates one example of the modulator 210, implemented as a reflective LCOS PLM 400 and shown in a partial cross-sectional view. As illustrated in FIG. 4, the PLM 400 includes a silicon backplane 410, a first electrode layer 420, a second electrode layer 430, a liquid crystal layer 440, a cover glass 450, and spacers 460. The silicon backplane 410 includes electronic circuitry associated with the PLM 400, such as CMOS transistors and the like. The first electrode layer 420 includes an array of reflective elements 421 disposed in a transparent matrix 422. The reflective elements 421 may be formed of any highly optically reflective material, such as aluminum or silver. The transparent matrix 422 may be formed of any highly optically transmissive material, such as a transparent oxide. The second electrode layer 430 may be formed of any optically transparent electrically conductive material, such as a thin film of indium tin oxide (ITO). The second electrode layer 430 may be provided as a common electrode corresponding to a plurality of the reflective elements 421 of the first electrode layer 420. In such a configuration, each of the plurality of the reflective elements 421 will couple to the second electrode layer 430 via a respective electric field, thus dividing the PLM 400 into an array of pixel elements. Thus, individual ones (or subsets) of the plurality of the reflective elements 321 may be addressed via the electronic circuitry disposed in the silicon backplane 410, thereby to modify the state of the corresponding reflective element 421.

The liquid crystal layer 440 is disposed between the first electrode layer 420 and the second electrode layer 430, and includes a plurality of liquid crystals 441. The liquid crystals 441 are particles which exist in a phase intermediate a solid and a liquid; in other words, the liquid crystals 441 exhibit a degree of directional order, but not positional order. The direction in which the liquid crystals 441 tend to point is referred to as the “director.” The liquid crystal layer 440 modifies incident light entering from the cover glass 450 based on the birefringence An of the liquid crystals 441, which may be expressed as the difference between the refractive index in a direction parallel to the director and the refractive index in a direction perpendicular to the director. From this, the maximum optical path difference may be expressed as the birefringence multiplied by the thickness of the liquid crystal layer 440. This thickness is set by the spacer 460, which seals the PLM 400 and ensures a set distance between the cover glass 450 and the silicon backplane 410. The liquid crystals 441 generally orient themselves along electric field lines between the first electrode layer 420 and the second electrode layer 430. As illustrated in FIG. 4, the liquid crystals near the center of the PLM 400 are oriented in this manner, whereas the liquid crystals 441 near the periphery of the PLM 400 are substantially non-oriented in the absence of electric field lines. By addressing individual ones of the plurality of reflective elements 421 via a phase-drive signal, the orientation of the liquid crystals 441 may be determined on a pixel-by-pixel basis.

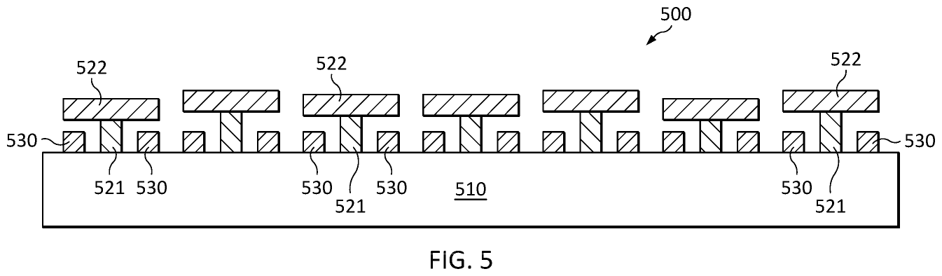

FIG. 5 illustrates another example of the modulator 210, implemented as a DMD PLM 500 and shown in a partial cross-sectional view. As illustrated in FIG. 5, the PLM 500 includes a backplane 510 and a plurality of controllable reflective elements as pixel elements, each of which includes a yoke 521, a mirror plate 522, and a pair of electrodes 530. While only two electrodes 530 are visible in the cross-sectional view of FIG. 5, each reflective element may in practice include additional electrodes. While not particularly illustrated in FIG. 5, the PLM 500 may further include spacer layers, support layers, hinge components to control the height or orientation of the mirror plate 522, and the like. The backplane 510 includes electronic circuitry associated with the PLM 500, such as CMOS transistors, a memory array, and the like.

The yoke 521 may be formed of or include an electrically conductive material so as to permit a biasing voltage to be applied to the mirror plate 522. The mirror plate 522 may be formed of any highly reflective material, such as aluminum or silver. The electrodes 530 are configured to receive a first voltage and a second voltage, respectively, and may be individually addressable. Depending on the values of a voltage on the electrodes 530 and a voltage (for example, the biasing voltage) on the mirror plate 522, a potential difference exists between the mirror plate 522 and the electrodes 530, which creates an electrostatic force that operates on the mirror plate 522. The yoke 521 is configured to allow vertical movement of the mirror plate 522 in response to the electrostatic force. The equilibrium position of the mirror plate 522, which occurs when the electrostatic force and a spring-like force of the yoke 521 are equal, determines the optical path length of light reflected from the upper surface of the mirror plate 522. Thus, individual ones of the plurality of controllable reflective elements are controlled to provide a number (as illustrated, three) of discrete heights and thus a number of discrete phase configurations or phase states. As illustrated, each of the phase states has a flat profile. In some aspects of the present disclosure, the electrodes 530 may be provided with different voltages from one another so as to impart a tilt to the mirror plate 522. Such tilt may be utilized with a light dump of the type described above.

The PLM 500 may be capable of high switching speeds, such that the PLM 500 switches from one phase state on the order of tens of us, for example. In order to provide for a full cycle of phase control, the total optical path difference between a state where the mirror plate 522 is at its highest point and a state whether the mirror plate 522 is at its lowest point should be approximately equal to the wavelength λ of incident light. Thus, the height range between the highest point and the lowest point should be approximately equal to λ/2.

In some implementations, the PLM 500 creates fixed diffraction orders, where the mirror plates 522 produce multiple “copies” of the light impinging onto them. The PLM 500 steers the light within the extent of each diffraction order, producing multiple image “copies” at the reconstruction plane. An image steered by the PLM 500 may be formed on an image reconstruction plane at a distance at which the diffraction orders separate without overlapping. In some implementations, the image reconstruction plane is closer to the PLM 500 to alleviate blurring of the reconstructed image. A Fourier filter is implemented with the PLM 500 to remove overlap of diffraction orders at the image reconstruction plane. In some implementations, the diffraction patterns constructively interfere with each other to form the reconstructed image. Accordingly, if a portion of the light steered by the PLM 500 is blocked, the reconstructed image blurs compared to a reconstructed image including all light from the PLM 500.

### Exemplary Fiber Input

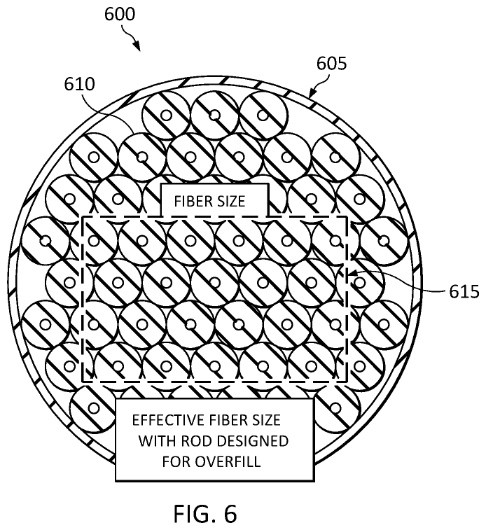

FIG. 6 provides one example optical fiber 600 for use with a light source (such as light source 102). The optical fiber 600 includes an outer cladding 605 and a plurality of inner fibers 610. The inner fibers 610 collectively form an output light projected by the optical fiber 600. In some implementations, the plurality of inner fibers 610 collectively form a circular light output provided to the illumination assembly 204. In other implementations, a subset of the inner fibers 610 are utilized to form a rectangular fiber output, shown by rectangular portion 615. The rectangular portion 615 may have an aspect ratio that matches a downstream modulator, such as the first modulator 106 and/or the second modulator 110. In some embodiments, the optical fiber 600 has an aspect ratio of a 16 by 9 array of the inner fibers 610.

### Example Projection Lens System

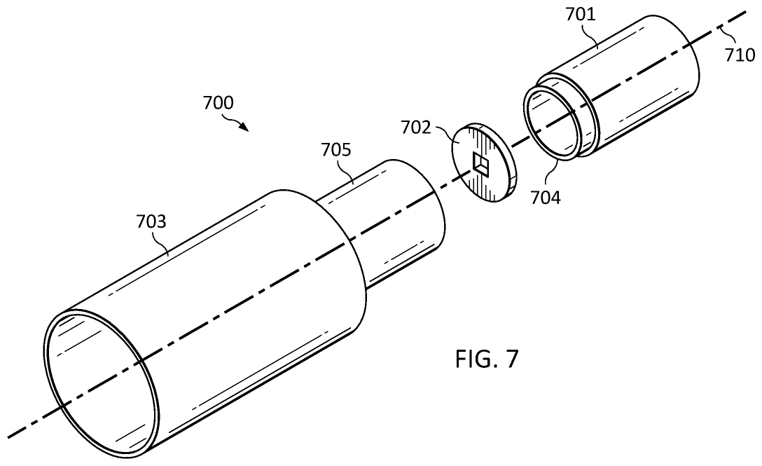

As previously described, modulated light from the modulation assembly is directed towards projection optics 214. In some implementations, the projection optics 214 is provided within a projection lens architecture. FIG. 7 is an exploded view of an exemplary projection lens system 700 according to various aspects of the present disclosure. The projection lens system 700 has a modular design. The projection lens system 700 includes a Fourier part 701 (for example, a Fourier lens assembly) configured to form a Fourier transform of an object at an exit pupil, an aperture 702 (illustrated as a square aperture), and a zoom part 703 (also referred to as a zoom lens assembly).

The spatial Fourier transform imposed by the Fourier part 701 converts the propagation angle of each diffraction order of the modulated light to a corresponding spatial position on the Fourier plane. The Fourier part 701 thereby enables selection of desired diffraction orders, and rejection of undesired diffraction orders, by spatial filtering at the Fourier plane. The spatial Fourier transform of the modulated light at the Fourier plane is equivalent to a Fraunhofer diffraction pattern of the modulated light.

The Fourier part 701 includes a first attachment section 704, which may include threads, fasteners, and the like. The zoom part 703 includes a second attachment section 705, which may include complementary threads, fasteners, and the like to allow for mating with the first attachment sections 704. In one example, the first attachment section 704 includes a male threaded portion and the second attachment section 705 includes a female threaded portion, or vice versa. In another example, the first attachment section 704 and the second attachment section 705 are configured for a friction fit, in which case one or more fastening elements such as screws, cams, flanges, and so on may be provided. In yet another example, the first attachment section 704 may include one or more radial pins and the second attachment section 705 may include a corresponding number of L-shaped slots, or vice versa, to thereby connect the Fourier part 701 and the zoom part 703 using a bayonet connection. By these examples, the Fourier part 701 may be removably attached to the zoom part 703 to provide a modular assembly.

While FIG. 7 illustrates the Fourier part 701 and the zoom part 703 as being entirely separable, the present disclosure is not so limited. In some implementations, the Fourier part 701 and the zoom part 703 are only partially separable, for example by provided an access portion in one of the Fourier part 701 and the zoom part 703. The access portion may be a slot, a door, a window, and the like, such that an operator may access and/or swap the aperture 702 via the access portion. In such implementations, the Fourier part 701 and the zoom part 703 may be bonded (e.g., via an adhesive on the first attachment section 704 and/or the second attachment section 705) to prevent full separation. Alternatively, the Fourier part 701 and the zoom part 703 may be provided with an integral housing that includes the attachment portion.

The aperture 702 is configured to block a portion of light (e.g., modulated light corresponding to one or more diffraction orders) in the projection lens system 700 (e.g., modulated light provided via the modulation assembly 206). As illustrated in FIG. 7, the aperture 702 is a square opening having sides of, for example, 6 mm in length. FIG. 7 also illustrates an optical axis 710 of the projection lens system 700. When assembled, the Fourier part 701 and the zoom part 703 are substantially coaxial with one another and with the optical axis 710. In some implementations (for example, depending on the illumination angle), the aperture 702 is not coaxial with the optical axis 710.

The projection lens system 700 may include or be associated with one or more non-optical elements, including a thermal dissipation device such as a heat sink (or cooling fins), one or more adhesives (or fasteners), and so on. In some implementations, the aperture 702 may block, and thus absorb, approximately 15% of incident light and therefore the heat sink or cooling fins may be positioned and configured so as to appropriately dissipate heat from the aperture 702. In some implementations, the aperture 702 is thermally isolated from other parts of the projection lens system 700.

The Fourier part 701 and the aperture 702 collectively operate as a Fourier lens with a spatial filter that may also be used as a fixed throw projection lens. The zoom part 703 illustrated in FIG. 7 may be one of a family of zoom lens assemblies configured to attach to the Fourier part 701, thereby to create the family of projection zoom lens systems and adapt to different theaters. In other words, the Fourier part 701 and the aperture 702 may be applicable to any theater setting, while the zoom part 703 provides a specific projection light pattern tailored to a particular theater. Therefore, by selecting a particular zoom part 703 from the family of zoom lens assemblies, and attaching the selected zoom part 703 to the Fourier part 701 and the aperture 702, a projection lens system 700 may be achieved which is adapted to the particular theater. Additionally, both the Fourier part 701 and the zoom part 703 may include a plurality of individual lens elements.

In some instances, the light passing through the aperture 702 has a high f-number value. The f-number (denoted f/#) is the ratio of the system's focal length to the diameter of the aperture 702. The f-number of light passing through the aperture 702 may be, for example, between f/9 and f/15. In some embodiments, the f-number of light passing through the aperture 702 is between f/15 and f/22. In some embodiments, the f-number of light passing through the aperture 702 is greater than f/22.

### Example Projection Lens Apertures

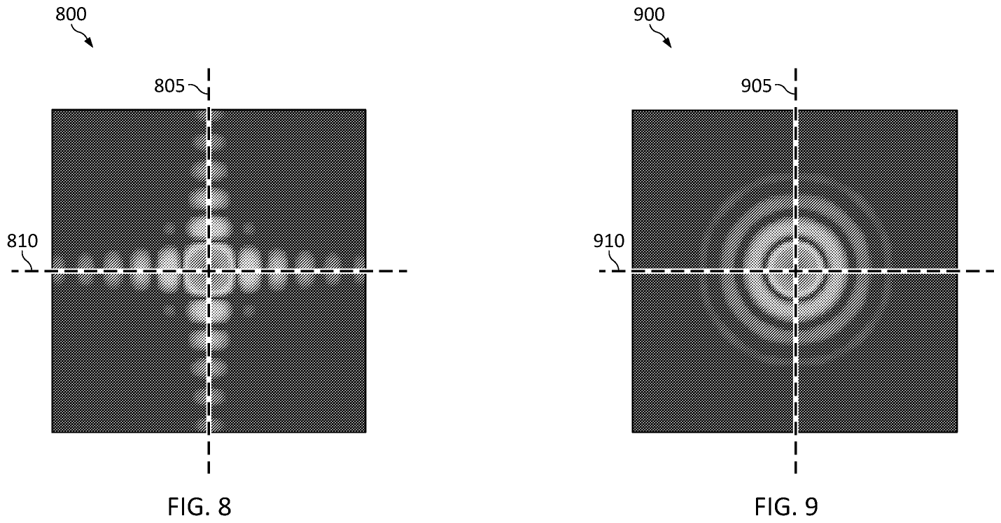

As previously stated, the aperture 702 may be a square opening having a length and a width. However, the diffraction of square apertures expand along the horizontal and vertical axis. For example, FIG. 8 provides an image of a point source 800 focused by a lens with a square aperture. As seen in FIG. 8, artifacts of the diffraction expand along vertical axis 805 and horizontal axis 810. As another example, the aperture 702 may have a circular opening. The area of the circular opening may be the same as the area of the square opening. The diffraction of circular apertures has less expansion. For example, FIG. 9 provides an image of a point source 900 focused by a lens with a circular aperture. As seen in FIG. 9, artifacts of the diffraction expand less along the vertical axis 905 and horizontal axis 910 compared to the artifacts of the square point source 800.

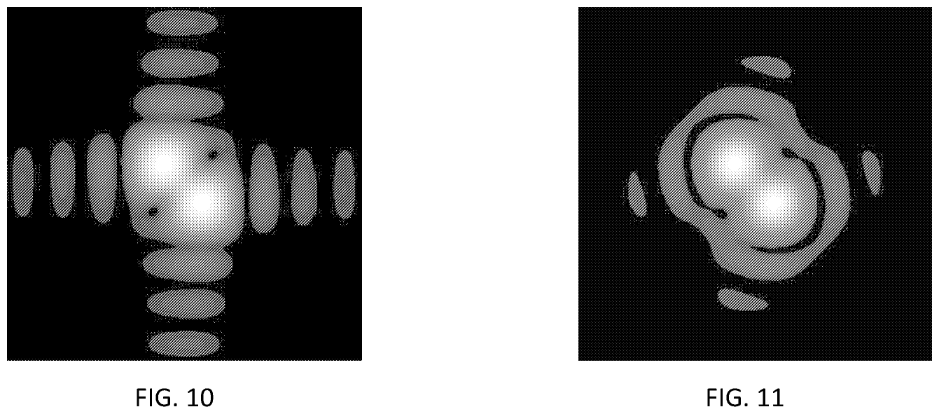

FIG. 10 illustrates a pixel focus of two modulator pixels (e.g., micromirrors 302) using a projection lens system 700 having a square aperture 702. FIG. 11 illustrates a pixel focus of two modulator pixels using a projection lens system 700 having a circular aperture 702. As the diffraction effects of the square aperture are vertically and horizontally orientated, light energy spills into area of an off-pixel (e.g., an OFF micromirror 302), reducing the contrast and perceived resolution of the image compared to the circular aperture.

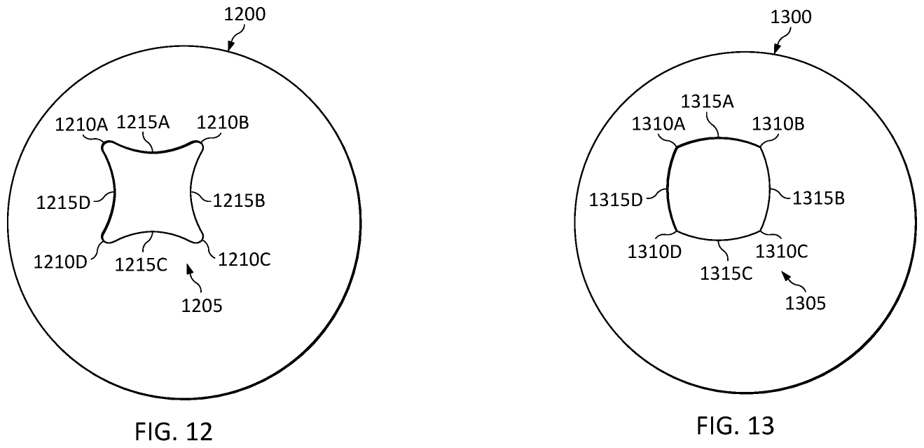

FIG. 12 illustrates an example aperture 1200 having a pincushion-shaped hole 1205 (e.g., a pincushion-shaped aperture). The pincushion-shaped hole 1205 includes a plurality of edges 1215 and a plurality of vertices 1210. In the illustrated example, the pincushion-shaped hole 1205 includes four edges 1215: a first edge 1215A, a second edge 1215B, a third edge 1215C, and a fourth edge 1215D. Additionally, in the illustrated example, the pincushion-shaped hole 1205 includes four vertices 1210: a first vertex 1210A, a second vertex 1210B, a third vertex 1210C, and a fourth vertex 1210D. However, other numbers of edges and vertices are considered, such as configurations including three edges and three vertices, five edges and five vertices, and greater or fewer numbers of edges and vertices.

The plurality of edges 1215 are concave portions that are shaped inwardly (e.g., curved inwardly) towards a center of the pincushion-shaped hole 1205. A depth or curvature of the plurality of edges 1215 is set according to an angle of the plurality of vertices 1210. In the illustrated example, the plurality of vertices 1210 are each an acute angle (e.g., less than 90°). In some implementations, the plurality of vertices 1210 are rounded to form “soft” corners. However, in other implementations, the plurality of vertices 1210 are “sharp” corners (e.g., not rounded).

FIG. 13 illustrates an example aperture 1300 having a pillow-shaped hole 1305 (e.g., a pillow-shaped aperture). The pillow-shaped hole 1305 includes a plurality of edges 1315 and a plurality of vertices 1310. In the illustrated example, the pillow-shaped hole 1305 includes four edges 1315: a first edge 1315A, a second edge 1315B, a third edge 1315C, and a fourth edge 1315D. Additionally, in the illustrated example, the pillow-shaped hole 1305 includes four vertices 1310: a first vertex 1310A, a second vertex 1310B, a third vertex 1310C, and a fourth vertex 1310D. However, other numbers of edges and vertices are considered, such as configurations including three edges and three vertices, five edges and five vertices, and greater or fewer numbers of edges and vertices.

The plurality of edges 1315 are convex portions that are shaped outwardly (e.g., curved inwardly) away from a center of the pillow-shaped hole 1305. An outward curvature of the plurality of edges 1315 is set according to an angle of the plurality of vertices 1310. In the illustrated example, the plurality of vertices 1310 are each an obtuse angle (e.g., greater than 90°). In some implementations, the plurality of vertices 1310 are rounded to form “soft” corners. However, in other implementations, the plurality of vertices 1310 are “sharp” corners (e.g., not rounded).

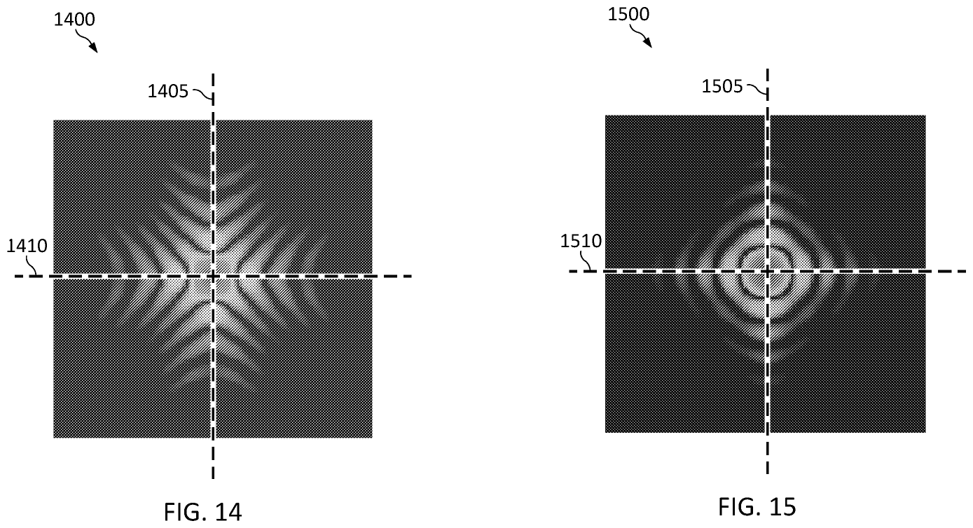

FIG. 14 provides an image of a point source 1400 focused by a lens having the pincushion-shaped aperture 1200. As seen in FIG. 14, artifacts of the diffraction expanding along vertical axis 1405 and horizontal axis 1410 are reduced compared to the square aperture of FIG. 8. FIG. 15 provides an image of a point source 1500 focused by a lens having the pillow-shaped aperture 1300. As seen in FIG. 15, artifacts of the diffraction expanding along vertical axis 1505 and horizontal axis 1510 are reduced compared to the square aperture of FIG. 8.

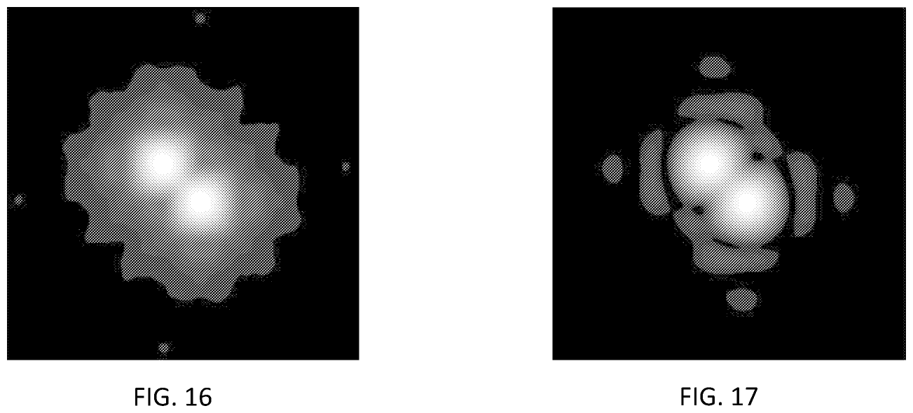

FIG. 16 illustrates a pixel focus of two modulator pixels (e.g., micromirrors 302) using a projection lens system 700 having the pincushion-shaped aperture 1200. FIG. 17 illustrates a pixel focus of two modulator pixels using a projection lens system 700 having the pillow-shaped aperture 1300. The amount of light energy spilling into areas outside of the two modulator pixels is reduced compared to that shown in FIG. 10.

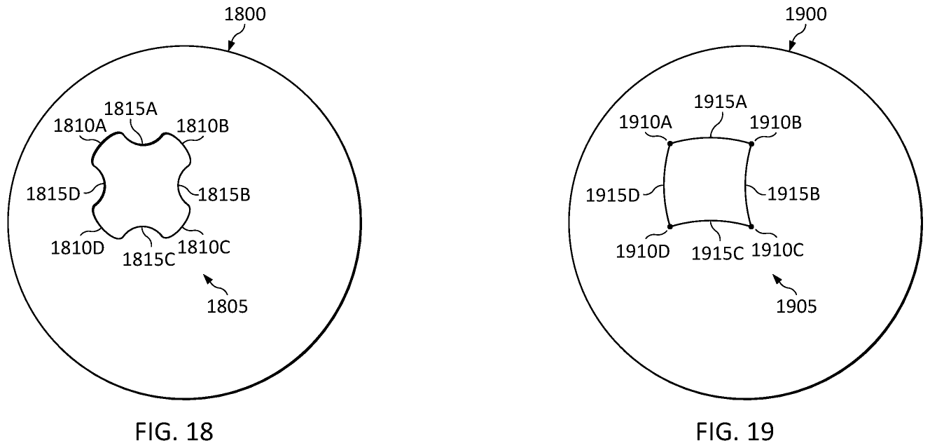

Other shapes for the aperture 702 are also considered. FIG. 18 illustrates an example aperture 1800 having a cross-shaped hole 1805 (e.g., a cross-shaped aperture). The cross-shaped hole 1805 includes a plurality of convex portions 1810 and a plurality of concave portions 1815. In the illustrated example, the cross-shaped hole 1805 includes four convex portions 1810: a first convex portion 1810A, a second convex portion 1810B, a third convex portion 1810C, and a fourth convex portion 1810D. Additionally, in the illustrated example, the cross-shaped hole 1805 includes four concave portions 1815: a first concave portion 1815A, a second concave portion 1815B, a third concave portion 1815C, and a fourth concave portion 1815D. However, other numbers of convex portions and concave portions are considered, such as configurations including three convex portion and three concave portions, five convex portion and five concave portions, and greater or fewer numbers of convex portions and concave portions.

While example shapes for the aperture 702 described herein have been symmetrical, asymmetric shapes are also possible. For example, in FIG. 12, each of the plurality of edges 1215 are shaped such that they curve inwardly towards a center of the pincushion-shaped hole 1205. In some instances, one, two, or three of the plurality of edges 1215 may be shaped such that they curve outwardly away from the center of the pincushion-shaped hole 1205. Additionally, with reference to FIG. 13, each of the plurality of edges 1315 are shaped such that they curve outwardly away from a center of the pillow-shaped hole 1305. In some instances, one, two, or three of the plurality of edges 1315 may be shaped such that they curve inwardly towards the center of the pillow-shaped hole 1305.

FIG. 19 provides an example aperture 1900 having an asymmetrical hole 1905. The

asymmetrical hole 1905 includes a plurality of vertices 1910 and a plurality of edges 1915. In the illustrated example, the asymmetrical hole 1905 includes four vertices 1910: a first vertex 1910A, a second vertex 1910B, a third vertex 1910C, and a fourth vertex 1910D. Additionally, in the illustrated example, the asymmetrical hole 1905 includes four edges 1915: a first edge 1915A, a second edge 1915B, a third edge 1915C, and a fourth edge 1915D. The first edge 1915A and the fourth edge 1915D are convex (e.g., curve outwards) with respect to a center of the asymmetrical hole 1905. The second edge 1915B and the third edge 1915C are concave (e.g., curve inwards) with respect to a center of the asymmetrical hole 1905. The first vertex 1910A is an obtuse angle. The third vertex 1910C is an acute angle. The second vertex 1910B and the fourth vertex 1910D are substantially right angles (e.g., approximately 90°).

Systems, methods, and devices in accordance with the present disclosure may take any one or more of the following configurations.
(1) A projection lens assembly for a projector system, comprising: an aperture integrated within the projection lens assembly and configured to block a portion of incident light, the aperture including an aperture hole composed of at least three edges and a plurality of vertices, wherein the at least three edges are curved relative to a center of the aperture hole.
(2) The projection lens assembly according to (1), further comprising: a Fourier lens assembly configured to form a Fourier transform of an object at an exit pupil of the Fourier lens assembly, wherein the aperture is disposed at approximately a plane of the Fourier transform.
(3) The projection lens assembly according to any one of (1) to (2), wherein the aperture hole is composed of four edges and four vertices.
(4) The projection lens assembly according to any one of (1) to (3), wherein the plurality of edges are each curved inward towards the center of the aperture hole.
(5) The projection lens assembly according to any one of (1) to (3), wherein the plurality of edges are each curved outward away from the center of the aperture hole.
(6) The projection lens assembly according to any one of (1) to (3), wherein at least one of the plurality of edges is curved inward towards the center of the aperture hole, and wherein at least one of the plurality of edges is curved outward away from the center of the aperture hole
(7) The projection lens assembly according to any one of (1) to (6), wherein each of the plurality of vertices are curved relative to the center of the aperture hole.
(8) The projection lens assembly according to any one of (1) to (7), wherein the incident light has a f-number between f/9 and f/15.
(9) The projection lens assembly according to any one of (1) to (8), wherein each of the plurality of vertices are acute angles.
(10) The projection lens assembly according to any one of (1) to (9), wherein each of the plurality of vertices are obtuse angles.
(11) A method of providing a projection lens system, comprising: providing a Fourier lens assembly configured to form a Fourier transform of an object at an exit pupil of the Fourier lens assembly, and disposing an aperture approximately at a plane of the Fourier transform, the aperture configured to block a portion of incident light, the aperture including an aperture hole composed of at least three edges and a plurality of vertices, wherein the at least three edges are curved relative to a center of the aperture hole.
(12) The method according to (11), wherein the aperture hole is composed of four edges and four vertices.
(13) The method according to any one of (11) to (12), wherein the plurality of edges are each curved inward towards the center of the aperture hole.
(14) The method according to any one of (11) to (12), wherein the plurality of edges are each curved outward away from the center of the aperture hole.
(15) The method according to any one of (11) to (12), wherein at least one of the plurality of edges is curved inward towards the center of the aperture hole, and wherein at least one of the plurality of edges is curved outward away from the center of the aperture hole.
(16) The method according to any one of (11) to (15), wherein each of the plurality of vertices are curved relative to the center of the aperture hole.
(17) The method according to any one of (11) to (16), wherein the incident light has a f-number between f/9 and f/15.
(18) The method according to any one of (11) to (17), wherein each of the plurality of vertices are acute angles.
(19) The method according to any one of (11) to (17), wherein each of the plurality of vertices are obtuse angles.
(20) A projector comprising: a light source configured to emit a light in response to an image signal, wherein the image signal includes image data; a modulator configured to receive the light from the light source and to apply a spatially-varying modulation on the light, thereby to steer the light and to generate a first steered light; and a projection lens assembly configured to receive the first steered light from the modulator, the projection lens assembly including an aperture configured to block a portion of incident light, the aperture including an aperture hole composed of a plurality of concave edges and a plurality of convex edges.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A projection lens assembly for a projector system, comprising:
an aperture integrated within the projection lens assembly and configured to block a portion of incident light, the aperture including an aperture hole composed of at least three edges and a plurality of vertices; and
a Fourier lens assembly configured to form a Fourier transform of an object at an exit pupil of the Fourier lens assembly, wherein the aperture is disposed at approximately a plane of the Fourier transform,
wherein the at least three edges are curved relative to a center of the aperture hole.

2. (canceled)

3. The projection lens assembly of claim 1, wherein the aperture hole is composed of four edges and four vertices.

4. The projection lens assembly of claim 1, wherein the plurality of edges are each curved inward towards the center of the aperture hole.

5. The projection lens assembly of claim 1, wherein the plurality of edges are each curved outward away from the center of the aperture hole.

6. The projection lens assembly of claim 1, wherein at least one of the plurality of edges is curved inward towards the center of the aperture hole, and wherein at least one of the plurality of edges is curved outward away from the center of the aperture hole.

7. The projection lens assembly of claim 1, wherein each of the plurality of vertices are curved relative to a center of the aperture hole.

8. The projection lens assembly of claim 1, wherein the incident light has a f-number between f/9 and f/15.

9. The projection lens assembly of claim 1, wherein each of the plurality of vertices are acute angles.

10. The projection lens assembly of claim 1, wherein each of the plurality of vertices are obtuse angles.

11. A method of providing a projection lens system, comprising:
providing a Fourier lens assembly configured to form a Fourier transform of an object at an exit pupil of the Fourier lens assembly, and
disposing an aperture approximately at a plane of the Fourier transform, the aperture configured to block a portion of incident light, the aperture including an aperture hole composed of at least three edges and a plurality of vertices,
wherein the at least three edges are curved relative to a center of the aperture hole.

12. The method of claim 11, wherein the aperture hole is composed of four edges and four vertices.

13. The method of claim 11, wherein the plurality of edges are each curved inward towards the center of the aperture hole.

14. The method of claim 11, wherein the plurality of edges are each curved outward away from the center of the aperture hole.

15. The method of claim 11, wherein at least one of the plurality of edges is curved inwards towards the center of the aperture hole, and wherein at least one of the plurality of edges is curved outward away from the center of the aperture hole.

16. The method of claim 11, wherein the plurality of vertices are curved relative to the center of the aperture hole.

17. The method of claim 11, wherein the incident light has a f-number between f/9 and f/15.

18. The method of claim 11, wherein each of the plurality of vertices are acute angles.

19. The method of claim 11, wherein each of the plurality of vertices are obtuse angles.

20. A projector comprising:
a light source configured to emit a light in response to an image signal, wherein the image signal includes image data;
a modulator configured to receive the light from the light source and to apply a spatially-varying modulation on the light, thereby to steer the light and to generate a first steered light; and
a projection lens assembly configured to receive the first steered light from the modulator, the projection lens assembly comprising:
an aperture configured to block a portion of incident light, the aperture including an aperture hole composed of a plurality of concave edges and a plurality of convex edges; and
a Fourier lens assembly configured to form a Fourier transform of an object at an exit pupil of the Fourier lens assembly, wherein the aperture is disposed at approximately a plane of the Fourier transform.
